(19) United States
(12) Patent Application Publication
(10) Pub. No.: US 2023/0303035 A1
(43) Pub. Date: Sep. 28, 2023

(54) WINDSHIELD WASHER SOLVENT HEATER

(71) Applicant: Kenneth LaBruyere, Washington, MI (US)

(72) Inventor: Kenneth LaBruyere, Washington, MI (US)

(21) Appl. No.: 17/656,452

(22) Filed: Mar. 25, 2022

(51) Int. Cl. B60S 1/48; F28D 7/00

(52) U.S. Cl. CPC B60S 1/488; F28D 7/0016; F28F 21/04

(57) ABSTRACT

A solvent heater for vehicular window washing solvent wherein the solvent heater is a vehicular exhaust pipe. There is a vessel having an inlet through which a washing fluid is received from a reservoir and an outlet through which the fluid is discharged for cleaning the window. There is a heating element for heating the fluid in the vessel, which element preheats the vessel before the washing fluid is received therein, whereby at least an initial quantity of the fluid is rapidly heated and discharged from the vessel.

### CROSS-REFERENCE TO RELATED APPLICATIONS

Not Applicable.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISC APPENDIX

Not Applicable.

### BACKGROUND OF THE INVENTION

The present invention is a solvent heater for vehicular window washing solvent. The applicant is aware of the following prior art in the field.

Various solvent heating devices and related devices are known in the art. For example, U.S. Pat. No. 5,383,247 entitled, “Washing Installation for Windshields or Motor Vehicles, Aircraft, Locomotives or The Like”, issued to Nickel on Jan. 24, 1995, teaches a cleaning installation for windshields of motor vehicles, aircraft, locomotives or the like with at least one wiper arm drivable by a wiper motor.

In another example, U.S. Pat. No. 7,775,224 entitled, “Windshield De-Icing” issued to Franco et al., on Aug. 17, 2010, teaches an apparatus for cleaning a window of a vehicle, including a vessel, having an inlet through which a washing fluid is received from a reservoir and an outlet through which the fluid is discharged for cleaning the window. There is a heating element for heating the fluid in the vessel, which element preheats the vessel before the washing fluid is received therein, whereby at least an initial quantity of the fluid is rapidly heated and discharged from the vessel.

Another example, U.S. Pat. No. 7,445,165 entitled, “Apparatus and Method for Windshield Cleaning and De-icing”, issued to Franco et al. on Nov. 4, 2008, teaches an apparatus for cleaning a window of a vehicle, including a vessel, having an inlet through which a washing fluid is received from a reservoir and an outlet through which the fluid is discharged for cleaning the window, a heating element for heating the fluid in the vessel, a controller for controlling flow of the fluid through the vessel and an actuator in wireless communication with the controller.

Another example, U.S. Pat. No. 7,171,716 entitled, “Windshield De-icing”, issued to Franco et al., on Feb. 6, 2007, teaches an apparatus for cleaning a window of a vehicle having an inlet through which a washing fluid is received from a reservoir and outlet through which the fluid is discharged for cleaning the window. There is a heating for heating the fluid in the vessel, which element preheats the vessel before the washing fluid is received therein, whereby at least an initial quantity of the fluid is rapidly heated and discharged from the vessel.

Another example, U.S. Pat. No. 6,892,417 entitled, “Windshield De-icing”, issued to Franco et al., on May 17, 2005, teaches an apparatus for cleaning a window of a vehicle having an inlet through which a washing fluid is received from a reservoir and outlet through which the fluid is discharged for cleaning the window. There is a means for heating the fluid in the vessel, which element preheats the vessel before the washing fluid is received therein, whereby at least an initial quantity of the fluid is rapidly heated and discharged from the vessel.

Another example, U.S. Pat. No. 6,669,109 entitled, “Apparatus For Cleaning or De-icing Vehicle Window”, issued to Ivanov et al., on Dec. 30, 2003 teaches an apparatus for cleaning or de-icing a vehicle window, including a reservoir for containing therein a washing fluid, a vessel having an inlet through which the washing fluid is received from the reservoir and an outlet through which the fluid is discharged for cleaning a vehicle window, and a first heating element disposed in the vessel for heating the fluid in the vessel, characterized by an auxiliary heating element being disposed in the vessel for heating the fluid in the vessel, wherein the auxiliary heating element is disposed at a bottom portion of the vessel and is operative to heat a quantity of fluid which is not necessarily sufficient to cover the first heating element.

### BRIEF SUMMARY OF THE INVENTION

In one embodiment of the instant invention there is a solvent heater for vehicular window washing solvent. The solvent heater comprises a heat exchanger mounted on a vehicle exhaust pipe surface. The heat exchanger has a high temperature flexible wrap surrounding the heat exchanger and the exhaust pipe. The heat exchanger has at least one restraining device for maintaining the heat exchanger and the flexible wrap to a portion of the vehicular exhaust pipe.

In another embodiment, the instant invention is a solvent heater for vehicular window washing solvent. The solvent heater comprises a heat exchanger mounted on an exhaust pipe surface of a vehicle. The heat exchanger has an inlet end and an outlet end. There is a check valve at a near end of the outlet end. The heat exchanger has a high temperature flexible wrap surrounding the heat exchanger and the exhaust pipe. The heat exchanger has at least one restraining device for maintaining the heat exchanger and the flexible wrap to a portion of the vehicular exhaust pipe.

Yet another embodiment of the instant invention is a solvent heater for vehicular window washing solvent. The solvent heater comprises a heat exchanger mounted on an outside surface of an exhaust pipe of a vehicle in a cured epoxy resin. The heat exchanger has a high temperature flexible wrap surrounding the heat exchanger and the exhaust pipe. The heat exchanger has at least one restraining device for maintaining the heat exchanger and the flexible wrap to a portion of the vehicular exhaust pipe.

There is a first liquid transfer line that has a first end and a second end. The first end is fluidly connected to the pump. The second end is fluidly connected to an inlet port of the heat exchanger. There is a second liquid transfer line that has a first end and a second end. The second liquid transfer line first end is fluidly connected to an outlet port of the heat exchanger. The second liquid transfer line second end is fluidly connected to at least one windshield washer ejection port. There is a check valve in the second liquid transfer line to prevent the liquid from returning to the heat exchanger.

### BRIEF DESCRIPTION OF THE SEVERAL VIEWS OF THE DRAWING(S)

FIG. 1 is a full side view of the solvent heater in place on an exhaust pipe of a vehicle.

FIG. 2 is a view of the solvent heater without the flexible wrap.

FIG. 3 is a solvent heater from the top showing the solvent heater in phantom.

FIG. 4 is a full top view of the solvent heater showing attachment of the heater to the vehicular exhaust pipe with epoxy.

FIG. 5 is a full top view of the solvent heater affixed to a vehicular exhaust pipe with a metal hose clamp.

FIG. 6 is a full side view of the solvent heater affixed to a vehicular exhaust pipe with epoxy.

FIG. 7 is a full view of the windshield washer system with the solvent heater.

### DETAILED DESCRIPTION OF THE INVENTION AND DRAWINGS

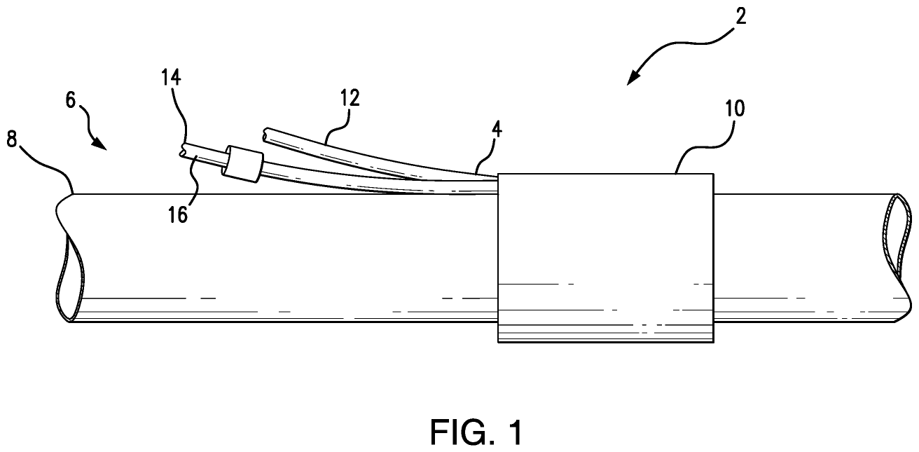

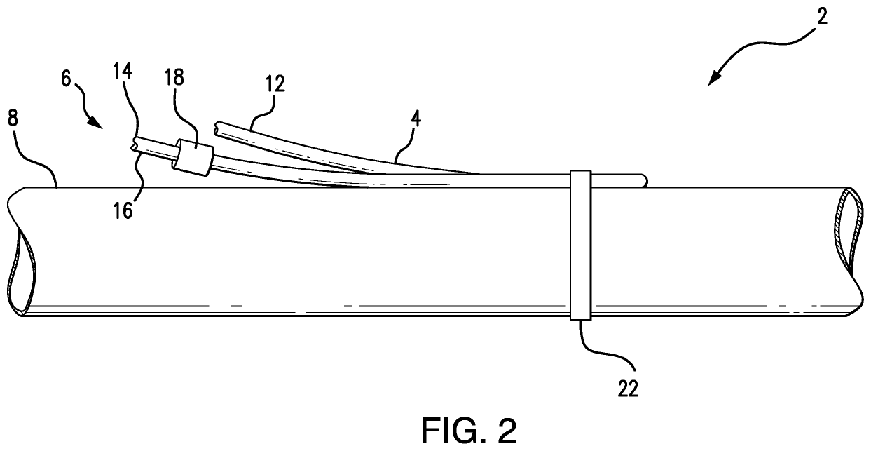

FIG. 1 shows the solvent heater 2 from the side. The solvent heater 2 is for heating vehicular window washing solvent. The solvent heater 2 comprises a heat exchanger 4 mounted on an exhaust pipe surface 6 of a vehicle. The heat exchanger 4 has an inlet end 12 and an outlet end 14. There is a check valve 18 at a near end 16 of the outlet end 14. The heat exchanger 4 has a high temperature flexible wrap 10 surrounding the heat exchanger 4 and the exhaust pipe 6. The heat exchanger 4 has at least one device 22 (shown in FIG. 2) for maintaining the heat exchanger 4 and the flexible wrap 10 to a portion of the vehicular exhaust pipe 6.

FIG. 2 shows the solvent heater 2 without the flexible wrap 10. The solvent heater 2 comprises a heat exchanger 4 mounted on an exhaust pipe surface 6 of a vehicle. The heat exchanger 4 has an inlet end 12 and an outlet end 14. There is a check valve 18 at a near end 16 of the outlet end 14. The heat exchanger 4 has a high temperature flexible wrap 10 surrounding the heat exchanger 4 and the exhaust pipe 6. The heat exchanger 4 has at least one restraining device 22 for maintaining the heat exchanger 4 and the flexible wrap 10 to a portion of the vehicular exhaust pipe 6.

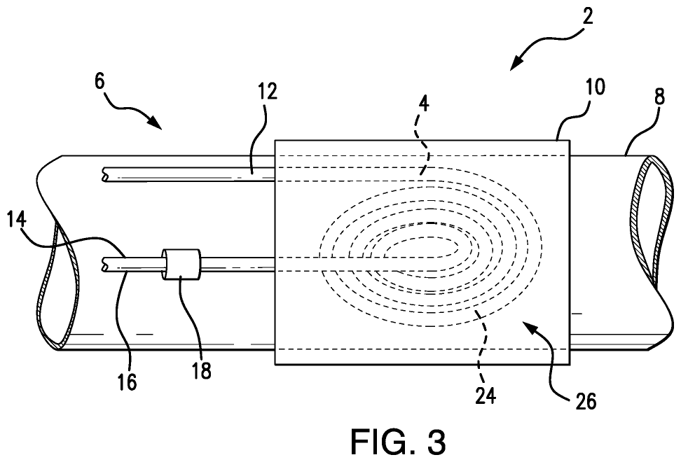

FIG. 3 shows the solvent heater 2 in phantom from the top through the flexible wrap 10. The solvent heater 2 comprises, a heat exchanger 4 mounted on an exhaust pipe surface 8 of a vehicle. The heat exchanger 4 has a high temperature flexible wrap 10 surrounding the heat exchanger 2 and the exhaust pipe 6. The heat exchanger 4 has at least one device 22 for maintaining the heat exchanger 4 and the flexible wrap 10 to a portion of the vehicular exhaust pipe 6. The present invention is in combination, the solvent heater 2 and a vehicular exhaust pipe 6. The present invention is a solvent heater 2 wherein the heat exchanger 4 is manufactured from metal, preferably aluminum. The present invention is a solvent heater 2 wherein the aluminum metal can be a hollow tube 24 that is coiled 26. The present device can be manufactured from copper and can also be in the form of a hollow tube 24 that is coiled 26.

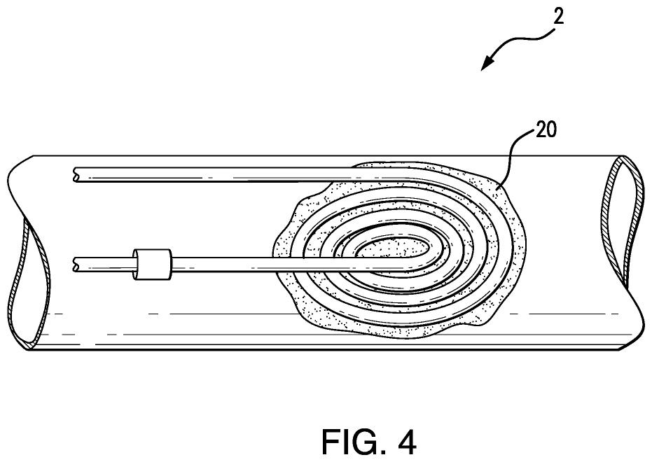

FIG. 4 shows the solvent heater 2 from the top affixed with epoxy 20. The solvent heater 2 comprises a heat exchanger 4 mounted on an outside surface 8 of an exhaust pipe 6 of a vehicle in a cured epoxy resin 20. The heat exchanger 4 has a high temperature flexible wrap 10 surrounding the heat exchanger 4 and the exhaust pipe 6. The heat exchanger 4 has at least one device 22 for maintaining the heat exchanger 4 and the flexible wrap 10 to a portion of the vehicular exhaust pipe 6.

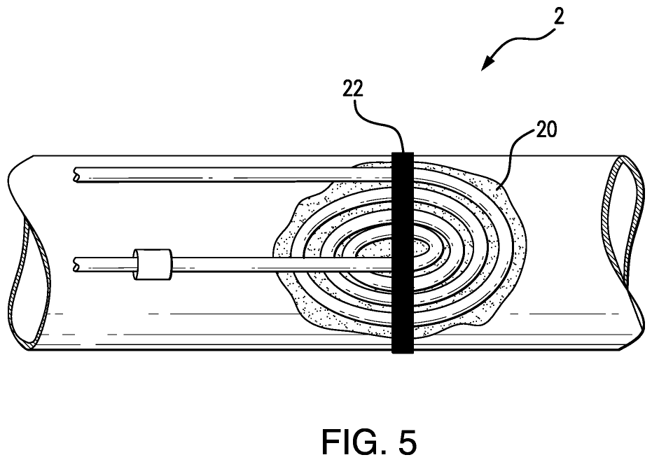

FIG. 5 show the solvent heater from the top affixed with a restraining device. The heat exchanger 4 has at least one device 22 for maintaining the heat exchanger 4 and the flexible wrap 10 to a portion of the vehicular exhaust pipe 6.

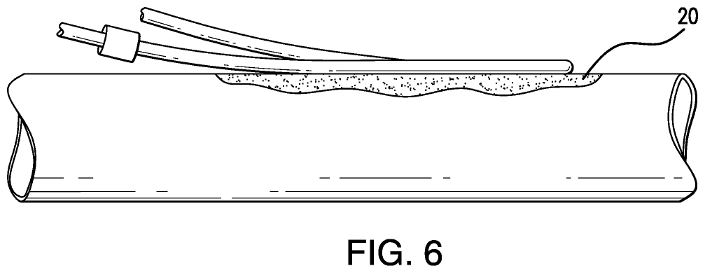

FIG. 6 shows the solvent heater from the side affixed with epoxy resin.

The present invention is a solvent heater wherein the heat exchanger is a ceramic heat exchanger. The present invention is a solvent heater wherein the heat exchanger is a heat resistant rubber hose.

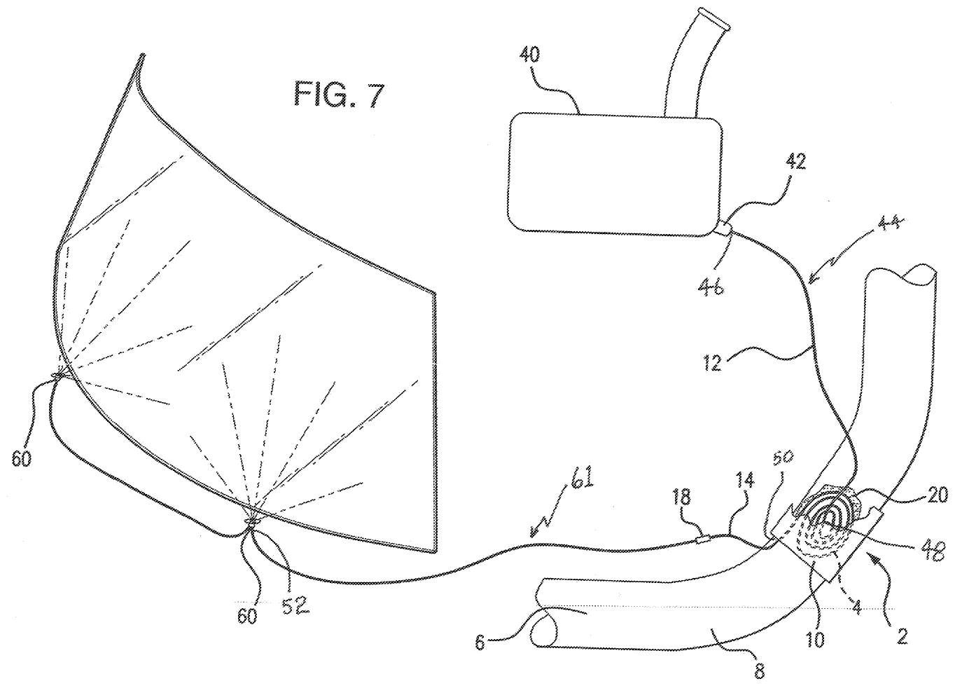

FIG. 7 is a full view of the windshield washer system with the solvent heater 2. The system comprises a reservoir 40 for storing liquids, a pump 42 for conveying liquids fluidly connected to the reservoir 40 and a heat exchanger 4 mounted on an exhaust pipe 6 of a vehicle.

The heat exchanger 4 has a high temperature flexible wrap 10 surrounding the heat exchanger 4 and the exhaust pipe 6. The heat exchanger 4 has at least one restraining device 22 for maintaining the heat exchanger 4 and the flexible wrap 10 to a portion of the vehicular exhaust pipe 6.

There is a first liquid transfer line 44 that has a first end 46 and a second end 48. The first end 46 is fluidly connected to the pump 42. The second end 46 is fluidly connected to an inlet port of the heat exchanger 4. There is a second liquid transfer line 48 that has a first end 50 and a second end 52. The second liquid transfer line 48 first end 50 is fluidly connected to an outlet port of the heat exchanger 4. The second liquid transfer line 48 second end 52 is fluidly connected to at least one windshield washer ejection port 60. There is a check valve 18 in the second liquid transfer line 48 to prevent the liquid from returning to the heat exchanger 4.

1.-10. (canceled)

11. A solvent heater for vehicular window washing solvent, said solvent heater comprising:
i. a heat exchanger mountable on an outside surface of an exhaust pipe of a vehicle in a cured epoxy resin;
ii. said heat exchanger having a high temperature flexible wrap surrounding said heat exchanger and said exhaust pipe;
iii. said heat exchanger having at least one restraining clamp for maintaining said heat exchanger and said flexible wrap to a portion of said vehicular exhaust pipe.

12. A windshield washing system, said system comprising:
(A) a reservoir for storing liquids;
(B) a pump for conveying liquids fluidly connected to said reservoir;
(C) a heat exchanger mounted on an exhaust pipe of a vehicle,
i) said heat exchanger having a high temperature flexible wrap surrounding said heat exchanger and said exhaust pipe;
ii) said heat exchanger having at least one clamp for maintaining said heat exchanger and said flexible wrap to a portion of said vehicular exhaust pipe;
(D) a first liquid transfer line having a first end and a second end, said first end fluidly connected to said pump, said second end being fluidly connected to an inlet port of said heat exchanger;
(E) a second liquid transfer line having a first end and a second end said second liquid transfer line first end being fluidly connected to an outlet port of said heat exchanger, said second liquid transfer line second end being fluidly connected to at least one windshield washer ejection port;
(F) there being a check valve in said second liquid transfer line to prevent said liquid from returning to said heat exchanger.
